(19) United States
(12) Patent Application Publication
(10) Pub. No.: US 2013/0016308 A1
(43) Pub. Date: Jan. 17, 2013

(54) LIQUID CRYSTAL DISPLAY ELEMENT, METHOD FOR MANUFACTURING SAME, AND LIQUID CRYSTAL DISPLAY DEVICE COMPRISING THE LIQUID CRYSTAL DISPLAY ELEMENT

(71) Applicants: Masao Urayama, Osaka (JP); Masanori Umeya, Tokyo (JP); Takahiko Muneyoshi, Chiba (JP)

(72) Inventors: Masao Urayama, Osaka (JP); Masanori Umeya, Tokyo (JP); Takahiko Muneyoshi, Chiba (JP)

(73) Assignees: Sharp Kabushiki Kaisha, Osaka (JP); Panasonic Liquid Crystal Display Co., Ltd., Hyogo (JP); Japan Display East Inc., Chiba (JP); Dai Nippon Printing Co., Ltd., Tokyo (JP)

(21) Appl. No.: 13/636,297

(22) PCT Filed: Jan. 21, 2011
(86) PCT No.: PCT/JP2011/051121

§ 371 Date: Sep. 20, 2012

(30) Foreign Application Priority Data
Mar. 31, 2010 (JP) 2010-083745

(51) Int. Cl. G02F 1/1339; H01J 9/26; G02F 1/13357

(52) U.S. Cl. 349/61; 349/153; 445/25

(57) ABSTRACT

A liquid crystal panel (9) includes a front substrate (1a) and a back substrate (1b), and a liquid crystal layer (3) provided between these substrates. A seal (4) is used to bond the front substrate (1a) and the back substrate (1b) together. A region where either of the pair of substrates is in contact with the liquid crystal layer (3) is divided into a display region (6) and a non-display region (5). The number of spacers (2) per unit area is larger in the display region (6) than in the non-display region (5). In other words, the density of the spacers (2) is different between the display region (6) and the non-display region (5), and the density of the spacers (2) is higher in the display region (6) than in the non-display region (5). According to this configuration, the display region (6) cannot be deformed significantly even under pressure from outside, and thus the non-display region (5) is deformed by the pressure.

### TECHNICAL FIELD

The present invention relates to a liquid crystal display element and a method for producing the liquid crystal display element, and a liquid crystal display device including the liquid crystal display element. More specifically, the present invention relates to a liquid crystal display element in which at least one of a pair of substrates that constitute the liquid crystal display element has flexibility and a method of producing the liquid crystal display element, and a liquid crystal display device including the liquid crystal display element.

### BACKGROUND ART

In recent years, a display device including a flat panel display (FPD) has been used more widely than a CRT display device which had conventionally been used most commonly. An example of the FPD is the one including, as a liquid crystal display element, (i) liquid crystal and (ii) a light emitting diode (LED) or an organic electroluminescence (organic EL) etc. Out of the FPDs, a display device using liquid crystal has been developed actively because of its advantages such as small thickness, lightweight, and low power consumption.

Generally, a liquid crystal display device is constituted by a backlight and a liquid crystal display element. The backlight is a surface light source device, and the liquid crystal display element is a liquid crystal panel. The liquid crystal panel is constituted by a back substrate, a front substrate, and liquid crystal sealed in between the back and front substrates. On the back substrate, thin film transistors (TFTs), pixel electrodes, and an alignment film etc. are provided. On the front substrate, a color filter, a counter electrode, and an alignment film etc. are provided. The front substrate and the back substrate are bonded together with a seal in the form of a frame. The seal serves as an adhesive agent which bonds the substances together and as a sealing agent to prevent liquid crystal sealed in between the substrates from leaking out of the substrates.

Recently, for the purpose of improving production efficiency of a liquid crystal display device, a study has been carried out to produce a liquid crystal display device by a roll-to-roll process. According to the roll-to-roll process, the step of forming the seal on the front substrate to the step of bonding the front substrate and the back substrate and curing the seal are carried out consecutively. To achieve this, a one-drop filling method (ODF method) is employed to supply liquid crystal. According to the ODF method, a liquid crystal layer is formed by, after the seal is applied to the front substrate so as to be in the form of a frame, dropping liquid crystal in predetermined quantities into the frame with use of a dispenser.

When supplying liquid crystal, it is necessary to supply a suitable amount of the liquid crystal. Otherwise, a gap of a liquid crystal cell changes, and predetermined performance of the liquid crystal panel cannot be achieved. This is because, if the gap of the liquid crystal cell is not uniform, the optical characteristics of the liquid crystal panel become not uniform, thereby causing display unevenness etc. For this reason, when a liquid crystal panel is produced by the ODF method, the amount of liquid crystal to be dropped is strictly determined according to the volume of a liquid crystal layer to be formed. As is clear from this, in order to carry out a high quality display, it is important to create a uniform, stable gap between substrates.

Meanwhile, although most of conventional back substrates and front substrates have been glass substrates, use of a plastic substrate such as a polyimide film is being attempted for the purpose of making those substrates lightweight and flexible. Also for a liquid crystal display device including such a flexible substrate, it is necessary to maintain a uniform, stable liquid crystal cell gap. However, since a flexible substrate does not have rigidity as compared to a glass substrate, the flexible substrate warps or bends etc. and a cell gap becomes ununiform. In view of this, Patent Literatures 1 and 2 each propose a special design to effectively maintain a uniform, stable cell gap of a liquid crystal panel.

Patent Literature 1 discloses a method of producing a liquid crystal display element, by which method to seal a liquid crystal filling opening under the condition where pressure is applied to a pair of substrates filled with liquid crystal from a direction perpendicular to the surfaces of the substrates. Specifically, a pair of substrates to which a seal has been applied are stacked on top of each other, and pressure is uniformly applied from a direction perpendicular to the surfaces of the substrates. Under the condition where pressure is being applied to the substrates, the seal is allowed to cure, liquid crystal is injected through the liquid crystal filling opening, and the liquid crystal filling opening is sealed. According to this method, when the liquid crystal filling opening is sealed, excess liquid crystal between the substrates comes out from the liquid crystal filling opening, and expansion of a gap between the substrates, which expansion has occurred when the liquid crystal was injected, is corrected. This makes the gap uniform. Meanwhile, the liquid crystal filling opening is sealed under this condition. This makes the uniform gap stably maintained thereafter.

On the other hand, Patent Literature 2 discloses a liquid crystal display element in which a columnar spacer is provided to a liquid crystal cell. Specifically, on one of a pair of substrates, the columnar spacer projecting toward the other of the substrates is provided. According to this configuration, since the area of a portion where the columnar spacer is in contact with the substrates is large, the both substrates are bonded together relatively firmly. Further, since it is possible to freely determine where to provide the columnar spacer, it is possible to combine the both substrates entirely uniformly. This makes the cell gap of the liquid crystal panel stably maintained, in particular in a case where the liquid crystal panel is prone to warping.

### CITATION LIST

### Patent Literatures

Patent Literature 1
Japanese Patent Application Publication, Tokukai, No. 2001-075111 A (Publication Date: Mar. 23, 2001)

Patent Literature 2
Japanese Patent Application Publication, Tokukai, No. 2006-338011 A (Publication Date: Dec. 14, 2006)

### SUMMARY OF INVENTION

### Technical Problem

The techniques disclosed in the Patent Literatures 1 and 2 described above are difficult to apply to a liquid crystal display device including a flexible substrate.

Specifically, considering handling etc. during the producing process, it is difficult to apply the production method for a liquid crystal display element disclosed in Patent Literature 1 to a flexible substrate having no rigidity. Therefore, it is difficult to achieve, by the producing method disclosed in Patent Literature 1, production of a liquid crystal display element including a flexible substrate in which a cell gap is made uniform. Further, Patent Literature 1 is based on the assumption that a liquid crystal layer is formed by a conventional filling vacuum injection method, and thus the steps of the production are complicated. Therefore, it is desired to employ a production method with higher productivity.

Further, if a back substrate and a front substrate are bonded together via a columnar spacer as is the case with the liquid crystal display element disclosed in Patent Literature 2, the following may occur. That is, in a case where a flexible substrate is used in a liquid crystal panel, if the liquid crystal panel is deformed, a stress is generated, and this stress may damage a portion where the substrates are bonded together.

In view of the circumstances, the present invention has been made in view of the object above, and an object of the present invention is to provide a liquid crystal display element capable of maintaining a uniform, stable cell gap of liquid crystal even when using a flexible substrate, and a method of producing the liquid crystal display element, and a liquid crystal display device including the liquid crystal display element.

### Solution to Problem

In view of the circumstances, the present invention has been made in view of the object above, and an object of the present invention is to provide a liquid crystal display element capable of maintaining a uniform, stable cell gap of liquid crystal even when using a flexible substrate, and a method of producing the liquid crystal display element, and a liquid crystal display device including the liquid crystal display element.

According to the configuration, the number of spacers per unit area is larger in the display region than in the non-display region. In other words, the density of the spacers is different between the display region and the non-display region, and is higher in the display region than in the non-display region. According to this configuration, the display region cannot be deformed significantly even under pressure from outside, and thus the non-display region is deformed by the pressure. Accordingly, even when pressure is applied from outside, the non-display region is deformed so that a substantially uniform cell gap can be maintained in the display region. This makes it possible, even when a flexible substrate is used in the liquid crystal display element in accordance with the present invention, to maintain a uniform cell gap in the display region.

Further, even if liquid crystal is injected into the liquid crystal panel in excess, excess liquid crystal in the display region is distributed to the non-display region. Accordingly, a substantially uniform cell gap is maintained in the display region. On the other hand, even if the amount of liquid crystal injected in the liquid crystal display element of the present invention is less than the necessary amount, the non-display region is deformed so that a smaller amount of liquid crystal is present in the non-display region. Accordingly, it is possible to maintain a substantially uniform cell gap in the display region. In this way, the non-display region serves as a buffer, and is deformed according to the amount of liquid crystal distributed. This makes it possible to maintain a uniform, stable cell gap in the display region regardless of the amount of liquid crystal sealed in the liquid crystal display element.

Further, in order to attain the above object, a liquid crystal display device in accordance with the present invention includes: any of the foregoing liquid crystal display elements; and a backlight.

According to the configuration, no unevenness occurs in the cell gap in the liquid crystal display element. Accordingly, it is possible to provide a liquid crystal display device that has a good display quality.

Further, in order to attain the above object, a method of producing a liquid crystal display element in accordance with the present invention is a method of producing the liquid crystal display element including a first substrate and a second substrate, a liquid crystal layer provided between the first and second substrates, and a seal for sealing the liquid crystal layer in between the first and second substrates and for bonding the first and second substrates together, said method including the steps of: forming a plurality of spacers in a display region of the first substrate and in a non-display region surrounding the display region; forming the seal on a surface of the first substrate on which surface the plurality of spacers are formed, the seal being formed so as to surround the plurality of spacers; forming the liquid crystal layer in a region surrounded by the seal; and bonding the plurality of spacers on the first substrate to the second substrate, and also bonding the first substrate to which the liquid crystal layer is provided and the second substrate together via the seal, in the step of forming the plurality of spacers, the number of spacers per unit area being larger in the display region than in the non-display region.

According to the method, it is possible to provide a liquid crystal display element capable of maintaining a uniform, stable cell gap in the display region.

Additional objects, features, and strengths of the present invention will be made clear by the description below. Further, the advantages of the present invention will be evident from the following explanation in reference to the drawings

### Advantageous Effects of Invention

According to a liquid crystal display element in accordance with the present invention, a display region cannot be significantly deformed even under pressure from outside, and thus a non-display region is deformed by the pressure. As a result, the non-display region serves as a buffer. This makes it possible to maintain a uniform, stable cell gap in the display region regardless of the amount of liquid crystal sealed in the liquid crystal display element.

### BRIEF DESCRIPTION OF DRAWINGS

FIG. 1 (a) of FIG. 1 is a view illustrating a top face of a liquid crystal panel in accordance with one embodiment of the present invention. (b) of FIG. 1 is a view illustrating a cross section of one area of the liquid crystal panel in accordance with one embodiment of the present invention. (c) of FIG. 1 is a view illustrating a cross section of one area of the liquid crystal panel in accordance with one embodiment of the present invention.

FIG. 2 is a view illustrating a top face of a liquid crystal panel in accordance with one embodiment of the present invention.

FIG. 3 is a view showing to what degree a cell gap of liquid crystal changes when the amount of sealed-in liquid crystal is changed.

FIG. 4 is a view showing to what degree a cell gap of liquid crystal changes when the amount of sealed-in liquid crystal is changed.

FIG. 5 (a) of the FIG. 5 is a view schematically illustrating the directions from which atmospheric pressure is applied to a liquid crystal panel. (b) of FIG. 5 is a view illustrating a cross section of a non-display region observed when liquid crystal whose volume is equal to the designed volume of a cell is sealed in. (c) of FIG. 5 is a view illustrating a cross section of the display region observed when liquid crystal whose volume is equal to the designed volume of a cell is sealed in. (d) of FIG. 5 is a view illustrating a cross section of a non-display region observed when liquid crystal whose volume is less than the designed volume of a cell is sealed in. (e) of FIG. 5 is a view illustrating a cross section of the display region observed when liquid crystal whose volume is less than the designed volume of a cell is sealed in.

FIG. 6 is a view showing to what degree the cell gap of the liquid crystal changes when the amount of sealed-in liquid crystal is changed.

### DESCRIPTION OF EMBODIMENTS

The following description discusses, with reference to the drawings, preferred embodiments of a liquid crystal display element in accordance with the present invention.

### (Configuration of Liquid Crystal Display Element)

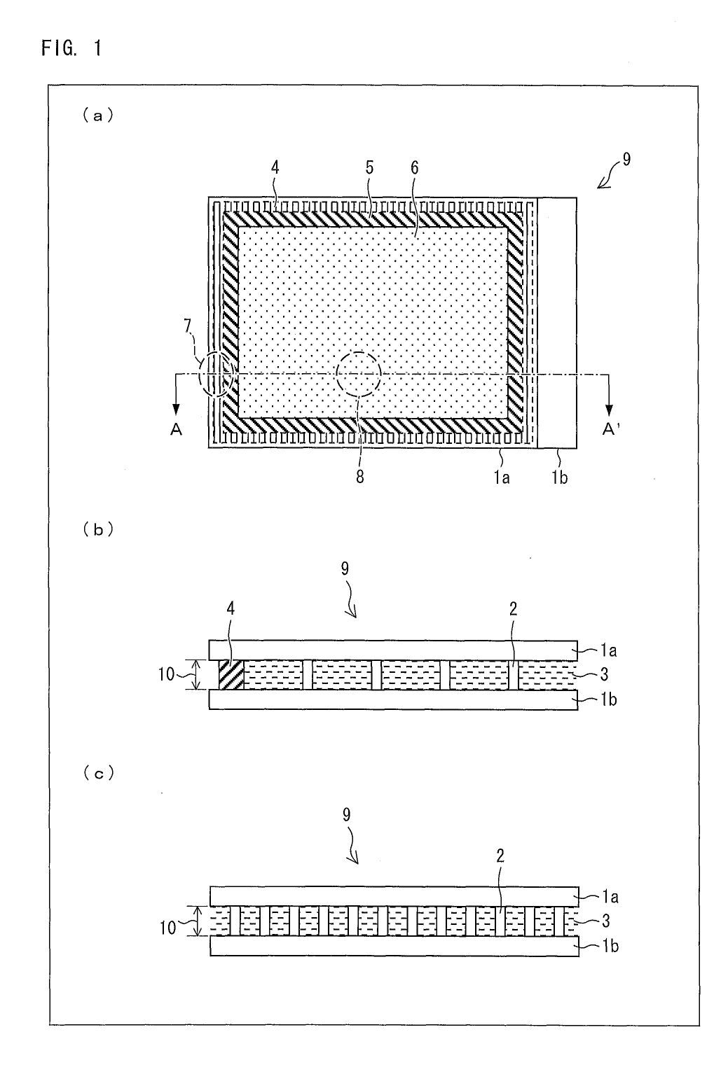

In general, a liquid crystal display device (LCD) is constituted by a backlight and a liquid crystal display element. The liquid crystal display device includes a surface light source device serving as the backlight, and a liquid crystal panel serving as the liquid crystal display element. A liquid crystal panel in accordance with the present embodiment is described with reference to FIG. 1. (a) of FIG. 1 is a view illustrating a top face of a liquid crystal panel 9. (b) of FIG. 1 is a view illustrating an A-A′ cross section of a region 7 shown in (a) of FIG. 1. (c) of FIG. 1 is a view illustrating an A-A′ cross section of a region 8 shown in (a) of FIG. 1.

As shown in (a) of FIG. 1, the liquid crystal panel 9 includes a pair of substrates (a front substrate 1a and a back substrate 1b) (a first substrate and a second substrate) and a liquid crystal layer 3 provided between the substrates. The front substrate 1a and the back substrate 1b are bonded together with a seal 4 in the form of a frame. The seal 4 serves as an adhesive agent which bonds the substrates together and as a sealing agent to seal liquid crystal in between the substrates so as to prevent the liquid crystal from leaking out of the substrates.

Moreover, in the front substrate 1a or the back substrate 1b of the liquid crystal panel 9, a region where the liquid crystal layer 3 is in contact with the substrate (i.e., a region surrounded by the seal 4) is divided into a non-display region 5 and a display region 6. As shown in (b) of FIG. 1, a plurality of spacers 2 are provided in the non-display region 5 so as to be spaced from each other. Similarly, as shown in (c) of FIG. 1, a plurality of spacers 2 are provided in the display region 6 so as to be spaced from each other. Note, here, that spaces between the plurality of spacers 2 provided in the non-display region 5 are larger than those between the plurality of spacers 2 in the display region 6. That is, the number of spacers 2 per unit area is larger in the display region 6 than in the non-display region 5.

The spacers 2 are for example columnar spacers formed by for example photolithography or spherical spacers dispersed by for example an ink-jet method. In a case of using columnar spacers 2, the columnar spacers 2 are not particularly limited as to their shapes, and can be in the form of cylinder or in the form of a rectangular column. The spacers 2 are formed by a method by which it is possible to control where to provide the spacers 2, and serve to maintain a uniform gap between the front substrate 1a and the back substrate 1b (i.e. a cell gap 10 of liquid crystal). This is described later in detail.

On respective surfaces of the front substrate 1a and the back substrate 1b which surfaces face each other (hereinafter, such surfaces are referred to as inner surfaces), transparent electrodes (not illustrated) such as indium tin oxide (ITO) films are provided. It is only necessary that at least one of the front and back substrates 1a and 1b be substantially transparent. The front and back substrates 1a and 1b can be glass substrates, ceramic substrates, plastic substrates or the like. Examples of the plastic substrates are those made from: cellulose derivatives such as cellulose, triacetyl cellulose, and diacetyl cellulose; polyesters such as polycycloolefin derivatives, polyethylene terephthalate, and polyethylene naphthalate; polyolefins such as polypropylene and polyethylene; polycarbonate; polyvinyl alcohol; polyvinyl chloride; polyvinylidene chloride; polyamide; polyimide; polyimideamide; polystyrene; polyacrylate; polymethyl methacrylate; polyether sulphone; polyarylate; and composites of inorganic and organic compounds such as glass fiber-epoxy resin and glass fiber-acrylic resin. Note that, according to the present embodiment, materials from which the front and back substrates 1a and 1b are made are not particularly limited provided that at least one of the substrates has flexibility. For example, even in a case where both of the glass substrates 1a and 1b are constituted by glass substrates, this configuration is encompassed in the present embodiment provided that at least one of them has flexibility.

The liquid crystal panel 9 can employ for example a simple matrix drive system or an active matrix drive system. Depending on the drive system of the liquid crystal panel 9, conductive wires, switching elements, and/or an insulating film are provided as appropriate to the inner surfaces of the front substrate 1a and the back substrate 1b. If necessary, alignment films having been subjected to alignment treatment are provided to the boundary face between the front substrate 1a and the liquid crystal layer 3 and to the boundary face between the back substrate 1b and the liquid crystal layer 3.

When the liquid crystal panel 9 is to be used in the liquid crystal display device, the liquid crystal panel 9 includes, in addition to the above constituents, (i) a color filter provided to the inner surface of the front substrate 1a and (ii) a polarization plate etc. provided to an outer surface (surface opposite the inner surface) of at least one of the front and back substrates 1a and 1b. Further, as described earlier, a surface light source device serving as a backlight that illuminates the liquid crystal panel 9 or a reflection plate etc. is attached to the liquid crystal panel 9. Since these configurations are the same as those of a conventional liquid crystal display device, descriptions for the configurations are omitted here.

### (Relationship Between Spacers 2 and Cell Gap 10)

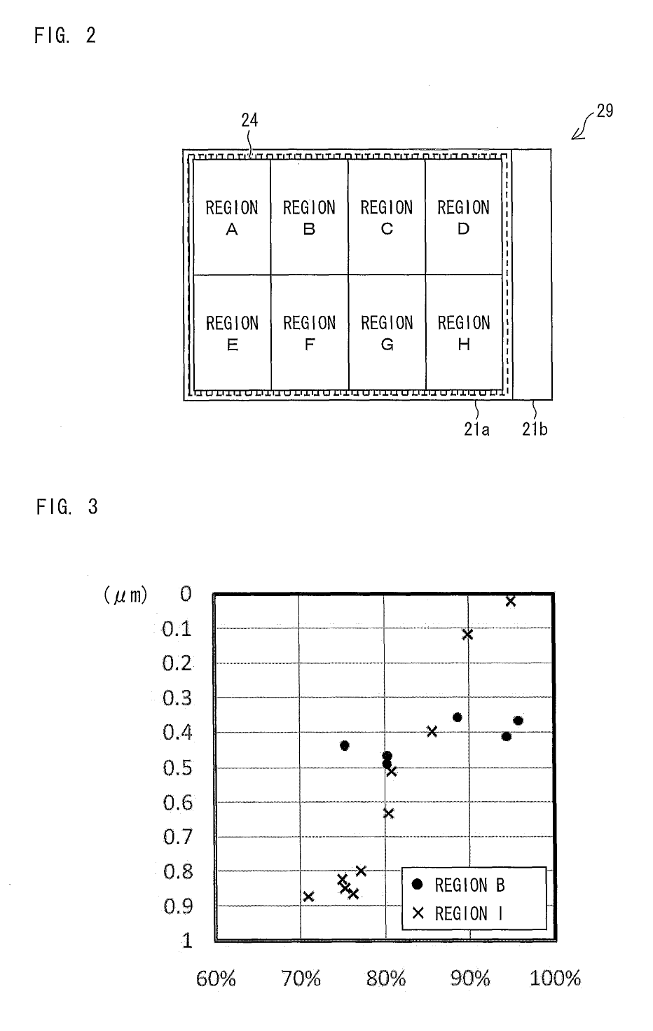

As described above, in the liquid crystal panel in accordance with the present embodiment, the plurality of spacers 2 are provided in the liquid crystal layer 3 so as to maintain a uniform cell gap 10 of liquid crystal. Note, here, that the present embodiment is characterized in that the density (the number of spacers 2 per unit area) of the plurality of spacers 2 differs from region to region. More specifically, the present embodiment is configured such that the density of the spacers 2 in the non-display region 5 is relatively low and the density of the spacers 2 in the display region 6 is relatively high. This makes the cell gap 10 in the display region 6 less affected by the amount of liquid crystal supplied, and the proper cell gap 10 can be stably maintained. The detailed mechanism of this is described with reference to an exemplary liquid crystal panel 29 as shown in FIG. 2. FIG. 2 is a view illustrating a top face of the liquid crystal panel 29 in which a region surrounded by the seal 24, which region is of a front substrate 21a or a back substrate 21b, is divided into eight regions.

TABLE 1

| | REGION | | | | | | | | |
|---|---|---|---|---|---|---|---|---|---|
| | A | B | C | D | E | F | G | H | I |
| SIZE | 225 | 225 | 225 | 225 | 900 | 900 | 900 | 900 | 225 |
| (μm² per | | | | | | | | | |
| spacer) | | | | | | | | | |
| DENSITY | 100 | 25 | 6.25 | 1.56 | 100 | 25 | 6.25 | 1.56 | 100 |
| OF | | | | | | | | | |
| SPACERS | | | | | | | | | |
| (the number | | | | | | | | | |
| of spacers | | | | | | | | | |
| per mm²) | | | | | | | | | |

As shown in FIG. 2, in the liquid crystal panel 29, the region surrounded by the seal 24 is divided into eight regions (A to H), and the spacers 2 are provided so that their density and size differ from region to region. Table 1 shows the density and the size of spacers 2 provided in each region. Note, here, that the size of a spacer 2 means the area of a portion where the spacer 2 is in contact with the front substrate 21a or the back substrate 21b. Further note that the region I in Table 1 is a region in a conventional liquid crystal panel, which includes spacers 2 of the same kind as the spacers 2 provided in the region B. As shown in Table 1, in the regions A to D, spacers 2 of small size (225 μm² per spacer) are used, and the density of the spacers 2 differs from region to region (1.56 to 100 spacers/mm²). On the other hand, in the regions E to H, spacers 2 of large size (900 μm² per spacer) are used, and the density of the spacers 2 differs from region to region (1.56 to 100 spacers/mm²).

The liquid crystal panel 29 is configured in the same manner as the liquid crystal panel 9 in accordance with the present embodiment, and includes the same constituents as those of the liquid crystal panel 9. Specifically, according to the liquid crystal panel 29, the front substrate 21a and the back substrate 21b are film substrates made from a glass fiber-acrylate resin composite, and the thickness of each of the substrates is 100 μm. On each of the inner surfaces of the substrates, a transparent electrode, columnar spacers 2, and an alignment film are formed sequentially. Further, between the front substrate 21a and the back substrate 21b, a liquid crystal layer in which twist nematic (TN) liquid crystal is sealed in with a seal 24 is provided.

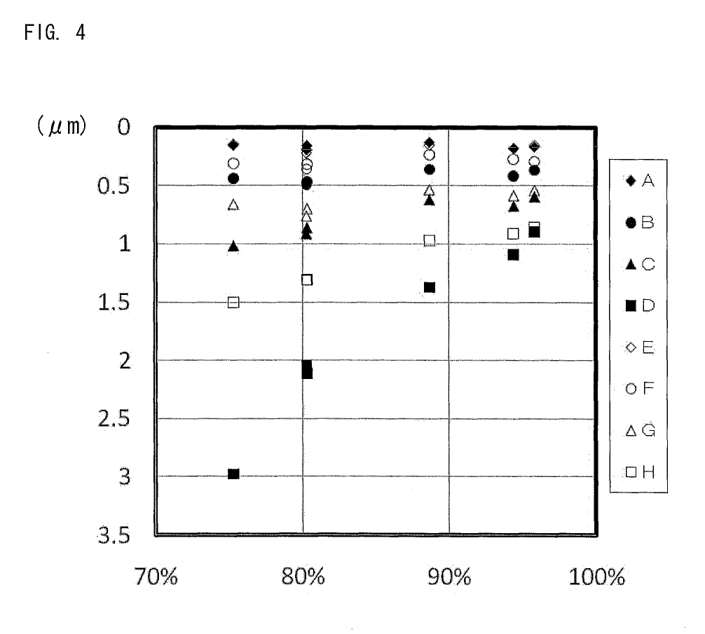

FIGS. 3 and 4 each show to what degree the cell gap 10 of liquid crystal in the liquid crystal panel 29 changes when the amount of the liquid crystal sealed in is changed. Specifically, each of FIGS. 3 and 4 shows, on the vertical axis, the amount obtained by subtracting, from the height of the spacers 2 under no-load condition, the cell gap 10 observed when liquid crystal is injected by an one-drop filling method (ODF method). Each of FIGS. 3 and 4 further shows, on the horizontal axis, the ratio of the amount of sealed-in liquid crystal to the designed volume of the cell. Note, here, that the designed volume of the cell is found by multiplying the area of a region where liquid crystal is sealed in (a region surrounded by the seal 24) by the height of each of the spacers 2 under no-load condition. Further note that all the measurements for the regions other than the region I are carried out by using a liquid crystal cell containing no vacuum bubbles.

First, the results obtained by measuring the regions B and I are shown in the FIG. 3. As described earlier, the spacers 2 provided in a liquid crystal cell in the region I are the same in density and size as those provided in the region B. In this case, the cell gap 10 changes as the amount of sealed-in liquid crystal is changed (see FIG. 3). A least-square fitting of the results shows that, as the amount of liquid crystal changes by 5% with respect to the designed volume of the cell, the cell gap 10 changes by 0.22 μm. This shows that, in order to maintain a uniform cell gap 10, it is important to accurately control the amount of liquid crystal to be supplied and the designed volume of the cell. Since the flexible substrate does not have rigidity, the flexible substrate warps or bends etc., thereby causing variations in the cell gap 10. This results in a reduction in display quality of the liquid crystal panel.

On the other hand, in the region B, the cell gap 10 does not significantly change even when the amount of sealed-in liquid crystal is changed (see FIG. 3). A least-square fitting of the results shows that the change of the cell gap 10 is reduced to one tenth that of the region I, and the cell gap 10 is substantially uniform regardless of the amount of liquid crystal supplied. Accordingly, it is possible to maintain a substantially uniform cell gap 10 even if the amount of liquid crystal supplied is changed. The following description discusses the reasons therefor in detail.

FIG. 4 shows the results obtained by measuring the regions A to H. As shown in FIG. 4, in the regions C, D, G and H where the density of spacers 2 is as low as 56 spacers per mm² or 6.25 spacers mm², the cell gap 10 significantly changes as the amount of liquid crystal is changed. In contrast, in the regions A, B, E and F where the density of spacers 2 is as high as 100 spacers per mm² or 25 spacers per mm², the cell gap 10 is substantially uniform regardless of the size of the spacers 2. Accordingly, the cell gap 10 does not change very much even if the amount of sealed-in liquid crystal is small relative to the designed volume of the cell. That is, the liquid crystal supplied to the liquid crystal panel 29 is first distributed to the regions A, B, E and F. After that, as more liquid crystal is supplied, liquid crystal in excess in the regions A, B, E and F flows into the regions C, D, G and H. In this way, the regions C, D, G and H where the density of the spacers 2 is low serve as a buffer for maintaining a uniform, stable cell gap 10 in the region A, B, E and F.

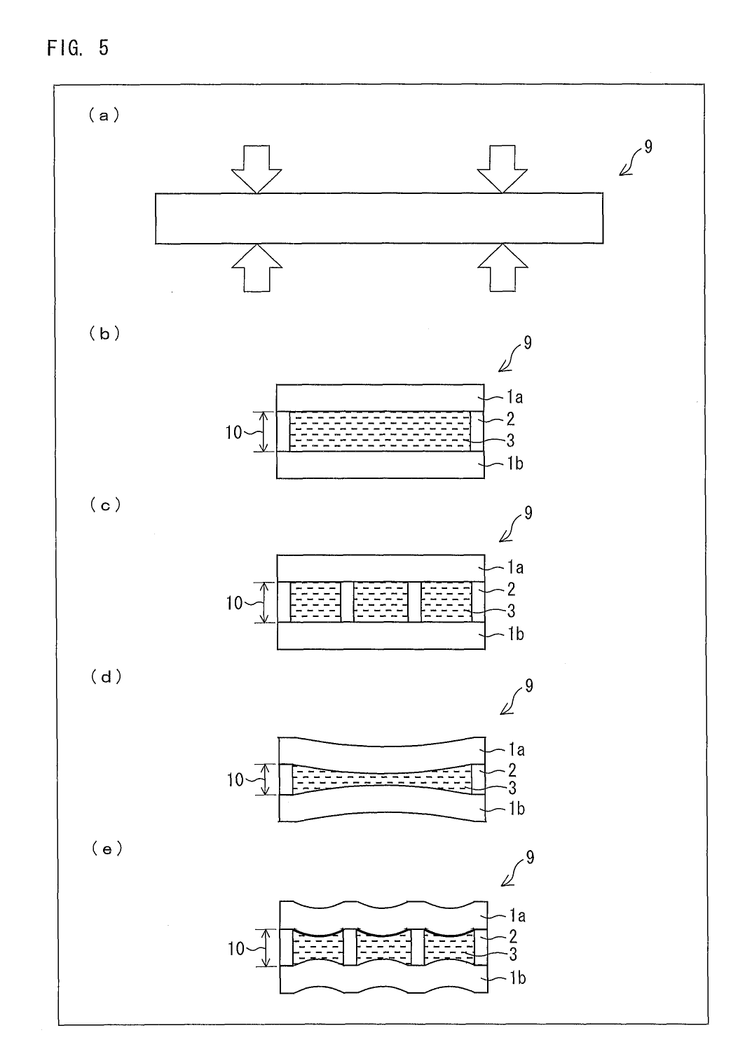

How liquid crystal is distributed depending on the difference in the density of the spacers 2 is described in detail with reference to FIG. 5. (a) of FIG. 5 is a view schematically illustrating directions from which atmospheric pressure is applied to the liquid crystal panel 9. (b) of FIG. 5 is a view illustrating a cross section of the non-display region 5 observed when as much liquid crystal whose volume is equal to the designed volume of the cell is sealed in. (c) of FIG. 5 is a view illustrating a cross section of the display region 6 observed when liquid crystal whose volume is equal to the designed volume of the cell is sealed in. (d) of FIG. 5 is a view illustrating a cross section of the non-display region 5 observed when liquid crystal whose volume is less than the designed volume of the cell is enclosed. (e) of FIG. 5 is a view illustrating a cross section of the display region 6 observed when liquid crystal whose volume is less than the designed volume of the cell is enclosed.

As described earlier, the present embodiment is configured such that (i) the density of the spacers 2 in the non-display region 5 is relatively low and (ii) the density of the spacers 2 in the display region 6 is relatively high.

As shown in (a) of FIG. 5, the liquid crystal panel 9 obtained by bonding the front substrate 1a and the back substrate 1b together uniformly receives pressure from atmosphere (i.e., from directions indicated by the arrows), which pressure corresponds to a difference between the designed volume of the cell and the volume of sealed-in liquid crystal. Note here that, in a case where liquid crystal whose volume is equal to the designed volume of the cell is sealed in, no pressure from atmosphere is applied because the designed volume of the cell and the volume of the sealed-in liquid crystal are the same (see (b) and (c) of FIG. 5). This occurs regardless of the density of the spacers 2. Therefore, the cell gap 10 in the non-display region 5 shown in (b) of FIG. 5 is equivalent to the cell gap 10 in the display region 6 shown in (c) of FIG. 5. Accordingly, in this case, it is possible to maintain a uniform, stable cell gap 10 both in the non-display region 5 and in the display region 6.

Note that, in a case where liquid crystal whose volume is less than the designed volume of the cell is sealed in, the liquid crystal panel 9 receives pressure from atmosphere which pressure corresponds to a difference between the designed volume of the cell and the volume of sealed-in liquid crystal (see (d) and (e) of FIG. 5). Note here that the non-display region 5 shown in (d) of FIG. 5 and the display region 6 shown in (e) of FIG. 5 receive equal pressure. However, since the density of the spacers 2 in the non-display region 5 is low, the spacers 2 in the non-display region 5 receive more pressure than those in the display region 6 where the density of the spacers 2 is high. As a result, the cell gap 10 in the non-display 5 shown in (d) of FIG. 5 becomes smaller than that in the display region 6 shown in (e) of FIG. 5.

Furthermore, since the density of the spacers 2 in the non-display region 5 is low, spaces between the spacers 2 are larger in the non-display region 5 than in the display region 6. Therefore, the entire non-display region 5 warps to a greater extent. As a result, the amount of liquid crystal per unit area in the non-display region 5 becomes less than in the display region 6.

As has been described, a region (display region 6) where the density of spacers 2 is high cannot be significantly deformed even under pressure from outside, and thus a region (non-display region 5) where the density of spacers 2 is low is deformed by the pressure. As a result, the cell gap 10 is kept constant in the region in which the density of the spacers 2 is high. As is clear from this, since the liquid crystal cell is made up of the region where the density of the spacers 2 is high and the region where the density of the spacers 2 is low, the region where the density of the spacers 2 is low serves as a buffer. Note here that, in order to cause the region where the density of the spacers 2 is low to serve as a buffer more effectively, it is preferable to use a flexible substrate. This makes it possible to easily change, by using the flexibility of the flexible substrate, the volume according to a change in the amount of liquid crystal.

Note that, although the present embodiment discusses an example in which the flexible substrates (the front substrate 1a and the back substrate 1b) are each 100 μm in thickness, the present invention is not particularly limited to this. For example, using a flexible substrate less than 100 μm in thickness is more effective, because such a flexible substrate has greater flexibility.

TABLE 2

| | REGION | | | | | | | |
|---|---|---|---|---|---|---|---|---|
| | A | B | C | D | E | F | G | H |
| SIZE | 225 | 225 | 225 | 225 | 900 | 900 | 900 | 900 |
| (μm² per spacer) | | | | | | | | |
| DENSITY OF | 100 | 25 | 6.25 | 1.56 | 100 | 25 | 6.25 | 1.56 |
| SPACERS (the | | | | | | | | |
| number of spacers | | | | | | | | |
| per mm²) | | | | | | | | |
| MAXIMUM | 0.07 | 0.13 | 0.42 | 2.08 | 0.08 | 0.12 | 0.23 | 0.65 |
| COMPRESSION | | | | | | | | |
| AMOUNT (μm) | | | | | | | | |

Table 2 shows maximum compression amounts, each of which is a difference between (i) the cell gap 10 obtained when the maximum amount of liquid crystal is sealed in each of the regions (A to H) shown in FIG. 4 and (ii) the cell gap 10 obtained when the minimum amount of liquid crystal is sealed in each of the regions (A to H) shown in FIG. 4. It is clear from Table 2 that, in the regions A to D, the maximum compression amount increases as the density of the spacers becomes low. Similarly, in the regions E to H, the maximum compression amount increases as the density of the spacers 2 becomes low. Note here that, out of the regions D and H where the density of the spacers 2 is the lowest, the region D has a greater maximum compression amount. The maximum compression amount in the region D is 2.08 μm. This means that the cell gap 10 can change by approximately 2 μm. That is, the region D serves a buffer for the amount of liquid crystal corresponding to its ability to change by approximately 2 μm.

As is clear from this, by providing in a single plane a plurality of regions which are different in density of the spacers 2, a region where the density of the spacers 2 is low serves as a buffer for a region where the density of the spacers 2 is high. This makes it possible to maintain a uniform, stable cell gap 10 in the region where the density of the spacers 2 is high, regardless of the amount of sealed-in liquid crystal.

According to the present embodiment, it is possible to cause the non-display region 5 to serve as a buffer by providing the spacers 2 in the non-display region 5 and in the display region 6 so that the density of the spacers 2 is lower in the non-display region 5 than in the display region 6. Specifically, even if liquid crystal is injected into the liquid crystal panel 6 in excess, liquid crystal excess in the display region 6 is distributed to the non-display region 5. Therefore, a substantially uniform cell gap 10 is maintained in the display region 6. On the other hand, even if the amount of liquid crystal sealed in the liquid crystal panel 9 is less than the necessary amount, the non-display region 5 is deformed so that a smaller amount of liquid crystal is present in the non-display region 5. Accordingly, it is possible to maintain a substantially uniform cell gap 10 in the display region 6. In this way, the non-display region 5 is deformed according to the amount of liquid crystal distributed. This makes it possible to maintain a uniform, stable cell gap 10 in the display region 6 regardless of the amount of liquid crystal sealed in the liquid crystal panel 9.

As such, according to the present embodiment, in a case where a flexible substrate is used, unevenness due to warping and/or bending of the cell gap 10 does not occur even if the liquid crystal panel 9 receives pressure from outside. On the other hand, the non-display region 5 can serve as a buffer and flexibly address the pressure by utilizing the flexibility of the flexible substrate. That is, according to the present embodiment, it is possible to maintain a uniform, stable cell gap 10 in the display region 6 even when a flexible substrate is used.

The foregoing description stated that the density of the spacers 2 in the non-display region 5 is preferably lower than that in the display region 6. More specifically, the density of the spacers 2 in the non-display region 5 is preferably less than or equal to one fourth that in the display region 6. This is because, if the density of the spacers 2 in the non-display region 5 is more than one fourth than that in the display region 6, the buffer effect utilizing a difference between the density of the spacers 2 in the non-display region 5 and the density of the spacers 2 in the display region 6 may decrease.

Further, the spacers 2 in the non-display region 5 are preferably larger in height than the spacers 2 in the display region 6. According to this configuration, since the height of each of the spacers 2 in the non-display region 5 is larger, it is possible to allow the non-display region 5 to be deformed to a great extent as compared to the case where the spacers 2 in the non-display region 5 are the same in height as the spacers 2 in the display region 6. This makes it possible to increase the amount of liquid crystal to be distributed to the non-display region 5, and thus possible to cause the non-display region 5 to functions as a buffer more effectively. Further, when the height of each of the spacers 2 in the non-display region 5 is larger, the non-display region 5 can sufficiently serve as a buffer even if the area of the non-display region 5 is small. For this reason, increasing the height of each of the spacers 2 in the non-display region 5 is an effective way to reduce the area of a frame of the liquid crystal panel 9.

Further, in a case where the spacers 2 are columnar spacers, it is possible to cause the non-display region 5 to serve as a buffer more effectively by changing the size of each of the spacers 2 instead of or in addition to changing the height of each of the spacers 2. For example, in the regions C and G, the density of the spacers 2 is the same both in the region C and the region G, whereas the size of each of the spacers 2 is larger in the region G than in the region C (see Table 2). Therefore, the spacers 2 in the region C are compressed more easily than those in the region G. Accordingly, the maximum compression amount in the region C is larger than that in the region G. The same is true with the region D and the region H.

Since the area where the spacers 2 are in contact with the front substrate 1a or the back substrate 1b is small in the non-display region 5 like above, the non-display region 5 is easily deformed. That is, by causing the density of the spacers 2 to differ from region to region, it is possible to change the degree to which a region where the density of spacers 2 is low is deformed. Note, however, that it is possible to control the degree to which the region is deformed, also by causing the size of the spacers 2 to differ from region to region.

Alternatively, the same effect can be achieved by causing the thicknesses of or the mechanical properties such as elastic modulus of the flexible substrates (the front substrate 1a and the back substrate 1b differ between the non-display region 5 and the display region 6. For example, at least one of the front and back substrates 1a and 1b can be configured to be thicker in the display region 6 than in the non-display region 5. This makes the non-display region easier to be deformed, and thus makes it possible to cause the non-display region 5 to effectively function as a buffer.

Alternatively, at least one of the front and back substrates of 1a and 1b can be configured to have an elastic modulus that is greater in the display region 6 than in the non-display region 5. This is because, assuming that the elastic modulus is Young modulus E, the elastic modulus is represented as ε=σ/E. Note that E represents strain and σ represents compression stress. In order to reduce the strain in the display region 6, it is only necessary to increase the elastic modulus (Young modulus). On the other hand, in order to increase the strain in the non-display region 5, it is only necessary to reduce the elastic modulus (Young modulus). This makes the non-display region 5 easily deformed, and thus makes it possible to cause the non-display region 5 to function as a buffer effectively. With such a configuration in which the volumes of the non-display region 5 and the display region 6 change by different amounts when pressure is applied from outside, a uniform, stable cell gap 10 is maintained more effectively in the display region 6.

### (Method of Producing Liquid Crystal Panel 9)

The following description discusses a method of producing the liquid crystal panel 9 in accordance with the present embodiment. Note that, as described earlier, the front substrate 1a and the back substrate 1b are configured to serve as a liquid crystal display. That is, the front substrate 1a and the back substrate 1b include an active matrix element array, a color filter, a transparent electrode, and/or an alignment film etc. Since how to make these members is the same as in the method of producing a conventional liquid crystal panel, its descriptions are omitted here. The following description discusses, in the order named, the step of forming spacers, the step of forming a seal, the step of forming a crystal layer, and the step of bonding. Note that it is preferable to employ a roll-to-roll process in the present embodiment. This is because, the step of forming spacers to the step of bonding are carried out as a series of steps, and thus the liquid crystal panel 9 can be produced more efficiently. This is also because the roll-to-roll process is suitably used in producing flexible substrates.

First, in the step of forming spacers, the spacers 2 are formed in the display region 6 and in the non-display region 5 surrounding the display region 6. The spacers 2 can be formed by for example photolithography. According to the photolithography, the spacers 2 can be formed concurrently in the non-display region 5 and in the display region 6 by forming, in advance, desired patterns of the spacers 2 in a photomask. The photography here is to obtain columnar spacers 2. In a case where spherical spacers 2 are used, an ink-jet method can be employed. It is only necessary that the spherical spacers 2 be applied separately to the non-display region 5 and the display region 6. Note, here, that the density and the size of the spacers 2 formed in the non-display region 5 and the display region 6 are each appropriately selected.

It should be noted that, before the step of forming spacers, it is preferable to stack a black matrix and color layers of RGB in the positions in the non-display region 5 where the spacers 2 are to be formed. This makes it possible to cause the height of each of the spacers 2 in the non-display region 5 to be larger than that of the spacers 2 in the display region 6 without carrying out additional steps. The height of each of the spacers 2 in the non-display region 5 can be controlled by controlling the number of the color layers stacked.

Next, in the step of forming a seal, a seal 4 in the form of a frame for defining a region where liquid crystal is to be sealed in is formed. The seal 4 can be formed by for example lithography using a dispenser or by screen printing. The seal 4 is formed on an inside surface of the front substrate 1a or of the back substrate 1b. The following description is based on the assumption that the seal 4 is formed on the inside surface of the front substrate 1a.

In the step of forming a liquid crystal layer, liquid crystal is supplied to the region surrounded by the seal 4 formed in the step of forming the seal. The liquid crystal can be supplied by for example a one-drop filling method (ODF method) or a filling vacuum injection method, but the ODF method is preferable in the present embodiment. This is because the ODF method corresponds to the roll-to-roll process, which is suitable for flexible substrates. When liquid crystal is supplied, the amount of the liquid crystal to be supplied is determined according to a designed volume of a cell, which is obtained by multiplying the area of the region surrounded by the seal 4 and the height of the spacers 2 under no-load condition. Note that, technically, the amount of liquid crystal to be supplied is determined in consideration of the designed volume of the cell and the volume of the spacers 2 provided in a liquid crystal cell. To this end, it is necessary to find the designed volume of the cell and the volume of the spacers 2 accurately. Therefore, it is difficult to accurately determine the amount of liquid crystal to be supplied. Note, however, that this is not a problem in the present embodiment for the following reason. That is, even if the amount of liquid crystal supplied is larger or smaller than the necessary amount, the non-display region 5 is deformed and thus a substantially uniform cell gap 10 can be maintained in the display region 6.

Lastly, in the step of bonding, the front substrate 1a and the back substrate 1b are bonded together. Specifically, (i) the front substrate 1a and the back substrate 1b are adsorbed to a stage having a structure such as an electrostatic chuck to which substrates are absorbed and (ii) the front substrate 1a and the back substrate 1b are arranged such the alignment film (inner surface) of the front substrate 1a and the alignment film (inner surface) of the back substrate 1b face each other and the seal 4 on the front substrate 1a does not make contact with the back surface 1b. Then, under this condition, pressure inside a system is reduced, and after the pressure has been reduced, the positions of the substrates are adjusted while portions of the front substrate 1a and the back substrate 1b, which portions are to be bonded, are being checked (alignment operation). After the portions to be bonded have been adjusted, the substrates are brought close to each other until the seal 4 on the front substrate 1a makes contact with the back substrate 1b. Under this condition, the system is filled with an inert gas, and pressure is gradually increased to normal pressure. With this, the front substrate 1a and the back substrate 1b are bonded together by atmospheric pressure, and the cell gap 10 corresponding to the height of each of the spacers 2 is formed. The seal 4 in an obtained panel is cured by irradiation with ultraviolet rays. This completes the liquid crystal panel 9.

The liquid crystal panel 9 formed like above is configured such that (i) the density of the spacers 2 is different between the non-display region 5 and the display region 6 and (ii) the density of the spacers 2 in the non-display region 5 is lower than that in the display region 6. This causes the non-display region 5 to function as a buffer. As such, it is possible to maintain a uniform, stable cell gap 10 in the display region 6 regardless of the amount of liquid crystal sealed in the liquid crystal panel 9.

Further, by producing the liquid crystal panel 9 by the roll-to-roll process like above, it is possible to produce the uniform, stable liquid crystal panel 9 with a high degree of repeatability.

The present invention is not limited to the descriptions of the respective embodiments, but may be variously altered within the scope of the claims. That is, an embodiment derived from a proper combination of technical means appropriately altered within the scope of the claims is encompassed in the technical scope of the invention.

For example, it is not necessary to say that a liquid crystal display device including, as a liquid crystal display element, the liquid crystal panel 9 in accordance with the present embodiment is encompassed in the present invention.

### Overview of Embodiment

As has been described, a liquid crystal display element in accordance with the present invention is characterized in that a spacer(s) in the display region is smaller in height than a spacer(s) in the non-display region.

According to the configuration, since the height of each of the spacers in the non-display region is larger, it is possible to cause the non-display region to be deformed to a great extent as compared to the case where the height of each of the spacers in the non-display region is the same as that of the spacers in the display region. As a result, the amount of liquid crystal that can be stored in the non-display region increases, and thus the non-display region more effectively functions as a buffer.

Further, the liquid crystal display element in accordance with the present invention is configured such that an area where a spacer(s) in the display region is in contact with either of the pair of substrates is larger than an area where a spacer(s) in the non-display region is in contact with either of the pair of substrates.

According to the configuration, since the area where the spacers in the non-display region are in contact with the substrates is small, the non-display region is easily deformed. As a result, the non-display region is deformed, and thus a substantially uniform cell gap can be maintained in the display region regardless of the amount of liquid crystal in the liquid crystal cell.

Further, the liquid crystal display element in accordance with the present invention is configured such that the number of spacers per unit area in the non-display region is equal to or less than one fourth the number of spacers per unit area in the display region.

According to the configuration, it is possible to cause the non-display region to sufficiently serve as a buffer by utilizing a difference in the density of spacers in the non-display region and the display region.

Further, the liquid crystal display element in accordance with the present invention is configured such that the plurality of spacers are columnar or spherical in shape.

According to the configuration, it is possible to allow, while maintaining a substantially uniform cell gap in the display region, the non-display region to be deformed by compression of the non-display region.

Further, the liquid crystal display element in accordance with the present invention is configured such that at least one of the pair of substrates is thicker in the display region than in the non-display region.

Further, the liquid crystal display element in accordance with the present invention is configured such that at least one of the pair of substrates has an elastic modulus that is greater in the display region than in the non-display region.

According to the configuration, a uniform cell gap can be maintained effectively in the display region, because the non-display region is more easily deformed.

The embodiments discussed in the foregoing description of embodiments and concrete examples serve solely to illustrate the technical details of the present invention, which should not be narrowly interpreted within the limits of such concrete examples, but rather can be applied in many variations within the spirit of the present invention, provided that such variations do not exceed the scope of the patent claims set forth below.

### Examples

The following description discusses, in more detail, the present invention on the basis of examples. Note, however, that the present invention is not limited to these examples unless it goes beyond the scope of the present invention.

In accordance with the foregoing production method, a 3.5-inch liquid crystal panel (QVGA) was produced. The spacers, which are columnar spacers, were formed by photolithography. The spacers in a display region of the liquid crystal panel were provided at a density of one spacer per QVGA pixel. On the other hand, the spacers in a non-display region were provided at a density of one fourth that in the display region. In both the display region and the non-display region, the area (the size of spacers) where the spacers are in contact with the front substrate or the back substrate was 225 μm² per spacer. The non-display region was formed around the display region so as to be 4.4 mm in width. Note here that, out of the volume of a liquid crystal cell thus formed, the ratio of the volume of the non-display region to the volume of the display region is approximately 10%. This ratio is calculated on the basis of the area of each of the regions and the height of each of the spacers in each of the regions.

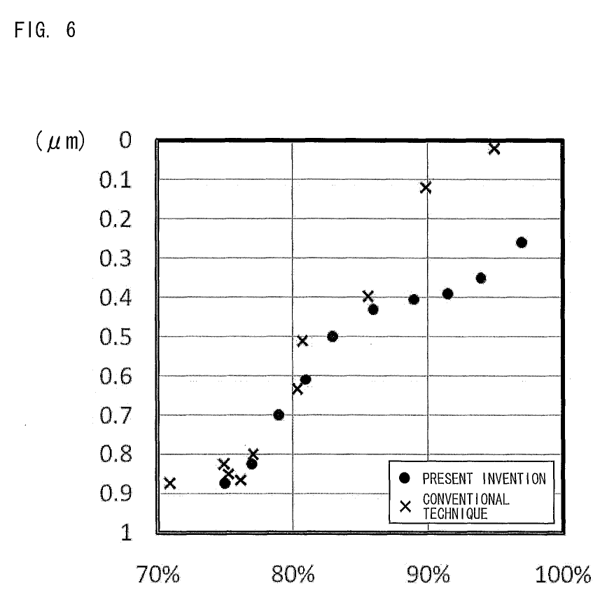

FIG. 6 shows to what degree the cell gap in liquid crystal changes when the amount of liquid crystal enclosed is changed. Specifically, FIG. 6 shows, on the vertical axis, the amount obtained by subtracting, from the height of the spacers under no-load condition, the cell gap observed when the liquid crystal is sealed in. FIG. 6 further shows, on the horizontal axis, the ratio of the amount of sealed-in liquid crystal to the designed volume of the cell. Note, here, that the designed volume of the cell is found by multiplying the area of a region in which liquid crystal is sealed in (region surrounded by the seal) by the height of each of the spacers under no-load condition. FIG. 6 shows the results obtained by measuring the display region in the liquid crystal panel in accordance with the present example (present invention) and the results obtained by measuring a display region in a conventional liquid crystal panel.

As shown in FIG. 6, according to the liquid crystal panel in accordance with the present example, the cell gap in the display region does not change significantly even when the amount of sealed-in liquid crystal is changed. On the other hand, according to the conventional liquid crystal panel, the cell gap in the display region changes significantly as the amount of sealed-in liquid crystal is changed. The reason therefor is as follows. According to the liquid crystal panel in accordance with the present example, the spacers are provided less densely in the non-display region than in the display region. Therefore, the non-display region can be deformed. Accordingly, even if the amount of sealed-in liquid crystal is changed, the non-display region is deformed so that a substantially uniform cell gap can be maintained in the display region. As such, according to the present example, it is possible to produce a liquid crystal cell in which a uniform, stable cell gap is maintained in a display region regardless of the amount of liquid crystal supplied.

### INDUSTRIAL APPLICABILITY

A liquid crystal display element in accordance with the present invention is applicable to liquid crystal display devices each of which displays an image with use of liquid crystal, such as those in a television receiver, a mobile phone, and a personal computer.

### REFERENCE SIGNS LIST

1a, 21a Front substrate
1b, 21b Back substrate
2 Spacer
3 Liquid crystal layer
4, 24 Seal
5 Non-display region
6 Display region
7, 8 Region
9, 29 Liquid crystal panel
10 Cell gap

1. A liquid crystal display element, comprising:
a pair of substrates at least one of which has flexibility;
a liquid crystal layer provided between the pair of substrates;
a seal for sealing the liquid crystal layer in between the pair of substrates and for bonding the pair of substrates together; and
a plurality of spacers provided in the liquid crystal layer,
a region where either of the pair of substrates is in contact with the liquid crystal layer being divided into a display region and a non-display region surrounding the display region, and
the number of spacers per unit area being larger in the display region than in the non-display region.

2. The liquid crystal display element according to claim 1, wherein a spacer(s) in the display region is smaller in height than a spacer(s) in the non-display region.

3. The liquid crystal display element according to claim 1, wherein an area where a spacer(s) in the display region is in contact with either of the pair of substrates is larger than an area where a spacer(s) in the non-display region is in contact with either of the pair of substrates.

4. The liquid crystal display element according to claim 1, wherein the number of spacers per unit area in the non-display region is equal to or less than one fourth the number of spacers per unit area in the display region.

5. The liquid crystal display element according to claim 1, wherein the plurality of spacers are columnar or spherical in shape.

6. The liquid crystal display element according to claim 1, wherein at least one of the pair of substrates is thicker in the display region than in the non-display region.

7. The liquid crystal display element according to claim 1, wherein at least one of the pair of substrates has an elastic modulus that is greater in the display region than in the non-display region.

8. A liquid crystal display device, comprising:
a liquid crystal display element recited in claim 1; and
a backlight.

9. A method of producing a liquid crystal display element, the liquid crystal display element including a first substrate and a second substrate, a liquid crystal layer provided between the first and second substrates, and a seal for bonding the liquid crystal layer in between the first and second substrates and for bonding the first and second substrates together,
said method comprising the steps of:
forming a plurality of spacers in a display region of the first substrate and in a non-display region surrounding the display region;
forming the seal on a surface of the first substrate on which surface the plurality of spacers are formed, the seal being formed so as to surround the plurality of spacers, or forming the seal on a surface of the second substrate which surface faces the plurality of spacers, the seal being formed so as to surround a region corresponding to the plurality of spacers;
forming the liquid crystal layer in a region surrounded by the seal; and
bonding the plurality of spacers on the first substrate to the second substrate, and also bonding the first and second substrates together via the seal,
in the step of forming the plurality of spacers, the number of spacers per unit area being larger in the display region than in the non-display region.
